(19) United States
(12) Patent Application Publication
(10) Pub. No.: US 2002/0116813 A1
(43) Pub. Date: Aug. 29, 2002

(54) Method for automatic handling of optical assemblies

(76) Inventors: Dane Scott, Doylestown, PA (US); Srikanth S. Maganti, Drifton, PA (US)

Correspondence Address: DANIEL H. GOLUB, 1701 Market Street, Philadelphia, PA, 19103, US

(21) Appl. No.: 09/996,816

(22) Filed: Nov. 30, 2001

Related U.S. Application Data
(60) Provisional application No. 60/270,980, filed on Feb. 23, 2001.
(60) Provisional application No. 60/270,979, filed on Feb. 23, 2001.

(51) Int. Cl. H01F 7/06

(52) U.S. Cl. 29/606; 29/605; 29/830

(57) ABSTRACT

A method for automatically assembling electro-optical devices are disclosed. A cassette receives an electronic module and an optical fiber, with or without a corresponding spool. An electronic module is loaded into the cassette. One end of the optical fiber is maintained for connection to a light source or light sensor and the other end is maintained for connection to the electronic module.

### CROSS REFERENCE TO RELATED APPLICATIONS

This application claims priority to U.S. Provisional Application Serial No. 60/270,980 entitled “Fiber Cassette” and U.S. Provisional Application Serial No. 60/270,979 entitled “Optical Fiber Spool and Cassette”, both filed Feb. 23, 2001.

### BACKGROUND OF THE INVENTION

1. Field of the Invention

The present invention relates to methods for automatically assembling electro-optical devices.

2. Description of the Background

In the production of optical systems including electro-optical systems, certain components must be optically connected to other components. This optical connection is typically accomplished by using flexible optical fibers with connectors on their ends. The use of a connector in such systems, however, generates a degradation of the signal either in a reduction of power or in added distortion. This is referred to as insertion loss. In many optical devices, therefore, one end of the fiber is connected directly to an electronic unit in order to eliminate one connector and reduce the system's insertion loss. This is normally done by the use of flexible optical fibers such as pigtails. Pigtails are glass fibers with specified coatings and have connectors installed on one end. They are normally obtained in lengths from a few inches to several feet. These fibers can be obtained with many different end terminations and are typically very fragile. Most of these fibers, for instance, cannot be bent in a curve with a radius that is less than 1.5 inches without suffering significant damage. The weight of typical end terminations on most pigtails presents a substantial risk of fiber damage during transportation and assembly. Also, the bare ends of fibers that are subject to direct connection are very fragile and must be protected from contact with any external surface at all times.

In order to assemble electro-optical systems, optical fibers are initially shipped from a fiber manufacturer. In connection with the shipping process, optical fibers undergo multiple manual processes. Optical fibers are normally air coiled, placed individually in plastic bags, and shipped from a vendor to a module manufacturer. There, the individual optical fiber is again subjected to numerous manual processes. The fiber packaging is opened manually. The optical fibers are uncoiled manually. The optical fibers are placed into equipment for manual assembly. These manual processes, particularly the shipping process and the assembly process, present a strong risk of damage to optical fibers. The fragile nature of pigtails, in particular, requires operator dexterity and does not lend itself to handling equipment normally used in automated assembly.

Once incorporated into an electro-optical assembly, in which a fiber is attached to an electronic module, the fiber is handled and shipped again. Once the fiber has been attached to an electronic module, however, its exposure to a substantial risk of damage increases. Handling the device, while these delicate fibers are hanging freely, and making connections to the attached fiber numerous times for fiber alignment and unit testing, generates a high probability of fiber fracture. Thus, the shipping of the finished device, with its attached fibers, typically requires manual manipulation of the fibers in properly sized loops and some method of immobilizing the fibers with respect to the body of the module. The device and the attached optical fibers must be placed in properly designed packing material. Fiber motion during shipment to the end user can generate defective units that may appear to be of high quality, but will not function properly in service.

In order to minimize the above-referenced risks, extreme care in handling during shipping and assembling is required. Nevertheless, small fractures can occur in the optical fibers that may not reveal themselves until the fracture grows sufficiently large to degrade the passage of light. This results in a reduction in the lifetime of the electro-optical assembly with the necessity of early unit replacement and resultant cost implications. Thus, there exists a need for a system and method for handling, transporting, and assembling optical fibers and optical assemblies, including electro-optical assemblies, that overcome the problems present in the prior art.

### BRIEF SUMMARY OF THE INVENTION

The present invention is directed to a method for automatically assembling an electro-optical device. The electro-optical device includes a cassette, one or more spools, and an electronic module. The method includes loading the one or more spools into a spool receiving area of said cassette, wherein the spools each capture a length of optical fiber (a first end and a second end). The method also includes loading the electronic module into an electronic module receiving area of the cassette; maintaining the first end of the fiber for connection to a light source or a light sensor; and maintaining the second end for connection to the electronic module.

The present invention is also directed to a method for automatically assembling an electro-optical device, wherein the electro-optical device includes a cassette, one or more lengths of optical fiber (which each include a first and second end), and an electronic module. The method includes loading the one or more lengths of optical fiber in an optical fiber receiving area of the cassette; loading the electronic module into an electronic module receiving area of the cassette; maintaining the first end for connection to a light source or a light sensor; and maintaining the second end for connection to the electronic module.

The present invention is further directed to a method for automatically assembling an electro-optical device, wherein the electro-optical device includes an electronic module, a cassette, and one or more lengths of optical fiber each having a first end and a second end. The lengths of optical fiber have been loaded into an optical fiber receiving area of the cassette. The method includes loading the electronic module into an electronic module receiving area of the cassette; maintaining the first end for connection to a light source or a light sensor; and maintaining the second end for connection to the electronic module.

### BRIEF DESCRIPTION OF FIGURES

The accompanying drawings, wherein like reference numerals are employed to designate the same or similar parts or steps, are included to provide a further understanding of the invention, are incorporated in and constitute a part of this specification, and illustrate embodiments of the invention that, together with the description, serve to explain the principles of the invention:

FIG. 1 shows a preferred embodiment of a spool assembly in accordance with the present invention.

FIG. 2 is an isometric, partially exploded view of a spool assembly in accordance with a preferred embodiment of the present invention.

FIG. 3 is an isometric view of a preferred embodiment of a spool assembly in accordance with the present invention.

FIG. 4 is an isometric, exploded view of a preferred embodiment of a spool assembly in accordance with the present invention.

FIG. 5 is an isometric view of a preferred embodiment of a spool assembly in accordance with the present invention.

FIG. 6 is an isometric view of a preferred embodiment of a spool assembly in accordance with the present invention.

FIG. 7 is an isometric view of a preferred embodiment of a two-spool assembly with one spool assembly partially exposed, in accordance with the present invention.

FIG. 8 is an isometric, exploded view of a preferred embodiment of a cassette assembly in accordance with the present invention.

FIG. 9 is an isometric, exploded view of a preferred embodiment of a cassette assembly in accordance with the present invention.

FIG. 10 is an isometric view of a preferred embodiment of a cassette assembly in accordance with the present invention.

FIG. 11 is an isometric, exploded view of a preferred embodiment of a cassette assembly in accordance with the present invention.

FIG. 12 is an isometric view of a preferred embodiment of a cassette assembly in accordance with the present invention.

FIG. 13 is a view of a preferred embodiment of a cassette assembly in accordance with the present invention.

FIG. 14A is an isometric view of a preferred embodiment of a cassette assembly in accordance with the present invention.

FIG. 14B is an isometric view of a preferred embodiment of a cassette assembly in accordance with the present invention.

FIG. 15 is an isometric view of a preferred embodiment of a cassette assembly in accordance with the present invention.

FIGS. 16A and 16B are flow charts illustrating a method for automatically assembling an electro-optical device in accordance with a preferred embodiment of the present invention.

FIGS. 17A, 17B and 17C are flow charts illustrating a method for automatically assembling an electro-optical device in accordance with a preferred embodiment of the present invention.

FIG. 18 is a flow chart illustrating a method for assembling a spool in accordance with a preferred embodiment of the present invention.

### DETAILED DESCRIPTION

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention while eliminating, for purposes of clarity, other elements.

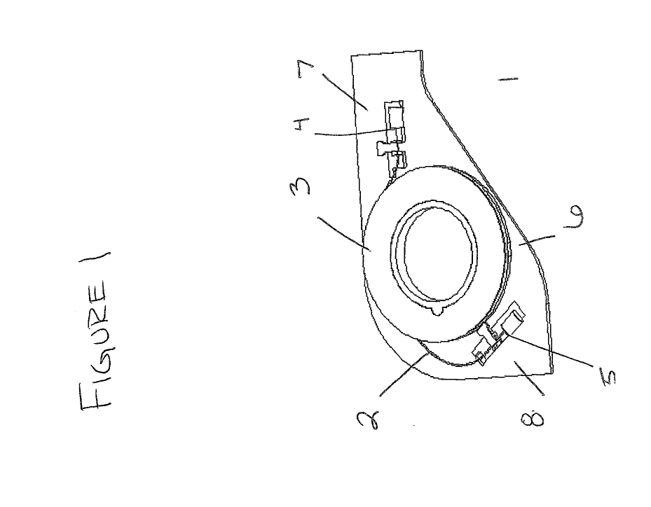

In one aspect of the present invention, a spool facilitates automatic handling of one or more lengths of optical fiber and can be used for storing, shipping, and further processing of the optical fibers, including facilitating manipulation of the optical fibers by automatic assembly equipment. With reference to FIG. 1, a spool assembly (1) is shown, which captures a length of optical fiber (2). Spool assembly (1) includes a drum (3) that receives the length of optical fiber (2). The length of optical fiber (2) has a first end (4) and a second end (5). Spool assembly (1) also includes a spool base (6), coupled to the drum (3). Spool base (6) includes at least two fiber end areas, fiber end area (7) and fiber end area (8), which retain the first end (4) and the second end (5) and prevent the length of optical fiber (2) from unspooling. At least a portion of fiber end area (7) and/or fiber end area (8) can be formed as inserts to accommodate various different types of fiber end configurations. Spool assembly (1) is sized and configure such that it is capable of being used in connection with automatic assembly equipment.

The general configuration of the spool described with reference to FIG. 1 can be used to accommodate many different types of assemblies. For example, this general configuration may accommodate an optical fiber with a connector or electronic element (such as a laser, lamp, diode, or sensor) on one end while leaving the other end bare. Alternatively, the spool may be configured to accommodate an optical fiber with connectors/electronic elements on each of its ends or, conversely, an optical fiber with two bare ends. Thus, the spool may be configured to accommodate fibers that are already connected to electronic elements; fibers that are connected to other fibers by splicing; or fibers that simply must be prevented from tangling in subsequent operations or during use. These accommodations may be easily achieved by changing the configuration of fiber end area (7) and/or fiber end area (8). Forming at least a portion of fiber end area (7) and/or fiber end area (8) as inserts is particularly advantageous in this regard.

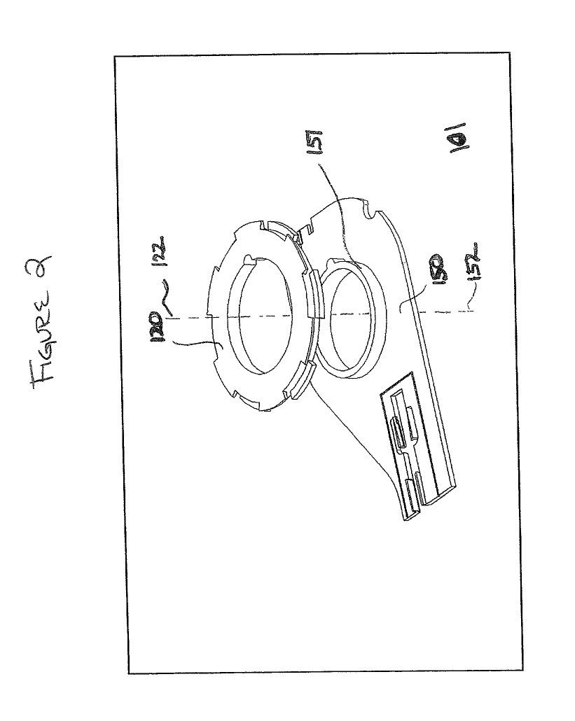

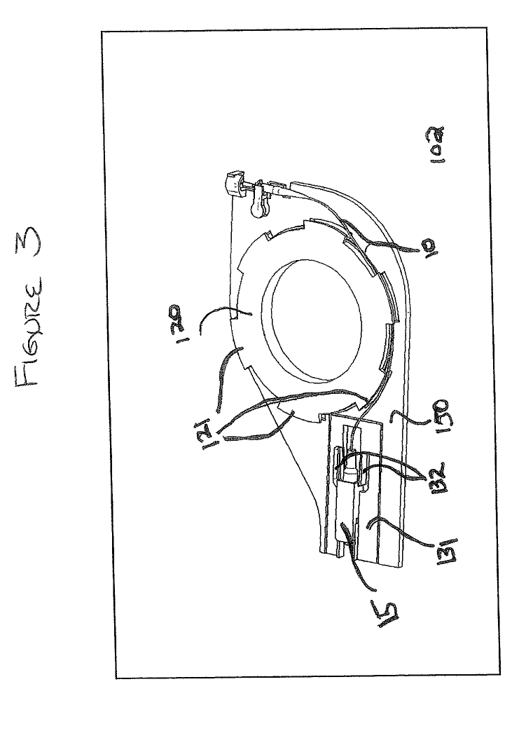

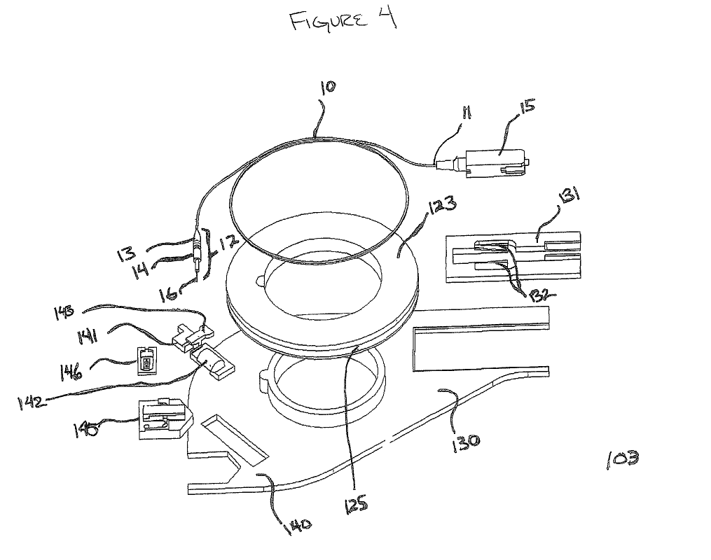

The following describes some specific preferred embodiments of the invention. As shown in FIG. 2, spool assembly (101) comprises a drum (120) and a spool base (150). The drum (120), which is used for receiving optical fibers, is coupled to the spool base (150) along the drum central axis (122) and the spool base central axis (152). The drum (120) and the spool base (150) can be formed as two separate units or, as shown in FIG. 3, as a single integrated unit. When made as separate units, as shown in FIG. 2, a drum molding (151) is used for coupling the drum (120) to the spool base (150). Drums, such as drum (120), can be constructed in different sizes to accommodate optical fibers of different lengths and diameters and coupled to the spool base (150) using the drum molding (151). In addition, this design allows for the substitution of different types of spool bases and corresponding fiber end entrapments, as discussed in more detail with reference to FIGS. 3 and 4.

As shown in FIG. 3, the spool assembly (102) includes a length of optical fiber (10). The drum (120) has flanges (121) to maintain the length of optical fiber (10) securely on the drum (120). In another embodiment, shown in FIG. 4, the drum (123) has a concave surface (125) on its outer diameter that retains the length of optical fiber. One end of the length of optical fiber (10) is held by a connector (15). The length of optical fiber (10) is wound around the drum (120) and the connector (15) is inserted in the connector clip (131) and held by connector locks (132). The connector clip (131) may be integral with the spool base (150) or may be formed as an insert, which allows for the use of different connector end configurations by inserting the particular connector clip that matches the desired connector end configuration. The spool assembly of the present invention, therefore, is versatile and enables accommodation of different pigtail terminations. The connector (15) is presented in fiber connector area (130) in a manner that allows for connection of connector (15) to a light sensor (if the electrical unit to which the fiber is to be connected is a transmitter) or a light source (if the electrical unit to which the fiber is to be connected is a receiver). Connector (15) may be connected to the light source/sensor by automatic assembly equipment. Alternatively, in some embodiments, connector (15) may be precisely positioned in fiber connector area (130) such that connection to a light source/sensor can be made without need for automatic assembly equipment.

As shown in FIG. 4, in module connection area (140) of the spool assembly (103), the assembly end (12) of the optical fiber (10) can be asserted into the fiber end latch (141). In particular, the bend limiter (13) on the assembly end (12) may be held in the fiber end latch (141) such that ferrule (14) is available for gripping by an assembly machine prior to its release from the latch (141) during optical assembly. Exerting pressure on tab (143) allows for release of the assembly end (12) from the latch (141). Upon its release, fiber end (16) can be, if required, automatically connected to an electronic module by an assembly machine. When maintained in the fiber end latch (141), the fiber end (16) is protected by the fiber end cover (142). The fiber end latch (141) may be constructed as an insert, which allows for the use of different end terminations by inserting the particular fiber end latch that matches the desired end termination.

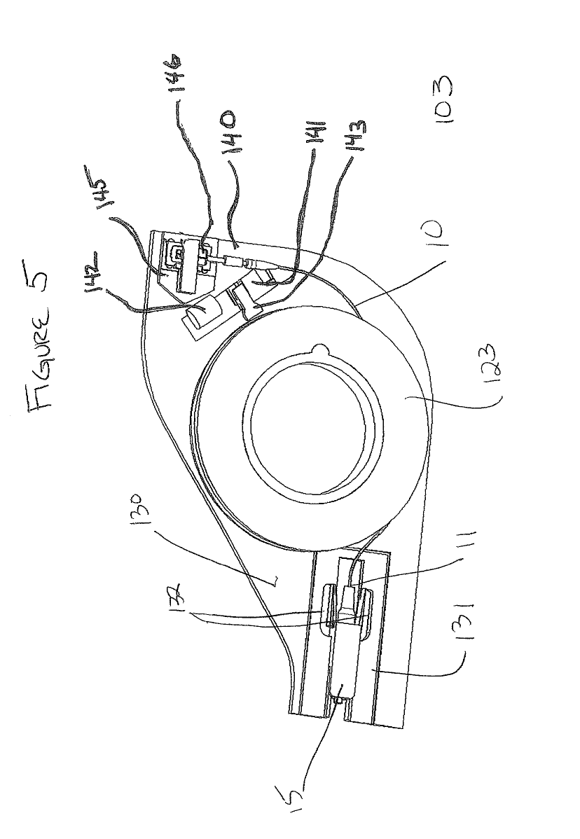

In accordance with the present invention, the spool assembly, such as that shown in FIG. 4, facilitates bonding of the optical fiber end to an electronic module (although, as stated previously, the invention covers spool systems that do not include electronic elements). For example, as shown in FIG. 4, the optical bench adapter (145) may be used to facilitate epoxy bonding during electro-optical assembly. The fiber end (16) held in the fiber end latch (141) may be released upon exerting pressure on the tab (143) of the fiber end latch (141). Upon release, as shown in FIG. 5, fiber end (16) may be inserted into optical bench (146), which is held in optical bench adapter (145). The optical bench adapter (145) may be constructed as an insert, which allows for the use of different bonding methods by inserting the desired optical bench adapter (145) into module connection area (140).

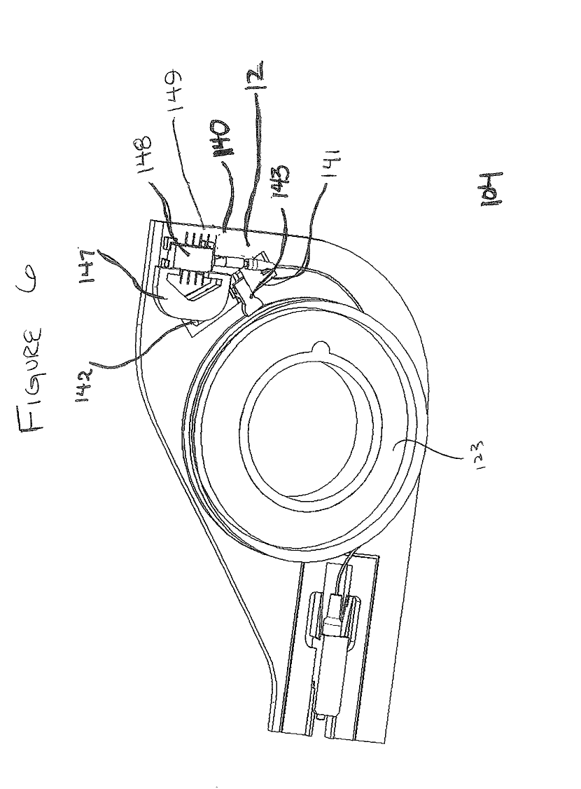

FIG. 6 depicts an alternate embodiment of the spool assembly of the present invention that provides for a different arrangement of module connection area (140), thereby facilitating a second type of optical fiber bonding. Module connection area (140) of spool assembly (104) is designed to facilitate assembly by laser welding. Electronic unit (148) is typically held by assembly equipment in a fixture appropriate for laser welding. The assembly end (12) held in the fiber end latch (141) is released upon exerting pressure on the tab (143). Automatic assembly equipment then properly positions fiber end (16) (not shown) with respect to the fixtured electronic unit (148), perform the weld, and removes the electronic unit (148) from the fixture with the fiber attached. The assembly equipment then deactivates latch (147) and inserts the electronic module (148) with the fiber end (16) attached into module adapter (149). Once the electronic module (148) and the attached fiber are in place, the latch (147) is activated, securely holding them in place. As shown in the FIG. 6, latch (147) may also be constructed as an insert, thereby providing for additional versatility.

The ability to form different portions of the spool assemblies of the present invention as inserts results in great versatility and enables accommodation of different connections and/or bonding methods.

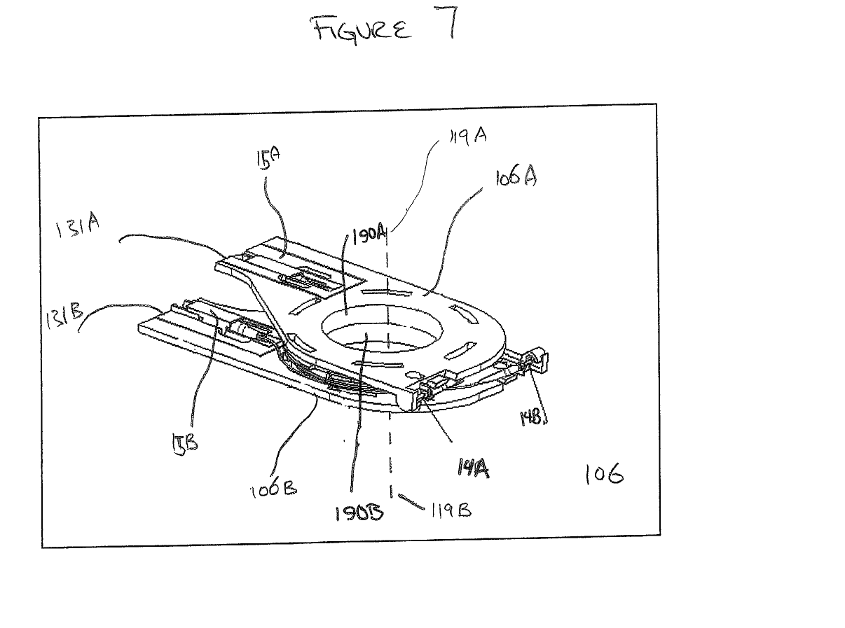

Two or more spools can be coupled together for use in handling or transporting optical fibers and assembling such optical fibers into optical assemblies (such as, for example, modulators, comb filters, multiplexers, frequency multipliers, amplifiers and other similar optical systems), in accordance with the present invention. As shown in FIG. 7, two spools (106A & 106B) are coupled to each other along the central axes (119A & 119B) of their respective drums (190A & 190B). Each connector (15A & 15B) is inserted into its respective connector clip (131A & 131B), thereby positioned for automatic connection to assembly equipment, if necessary. Each ferrule (14A & 14B) is positioned for automatic pickup by assembly equipment.

Once an optical fiber has been captured on a spool, the spool can be used to store the optical fiber and to ship the optical fiber, for example, from a vendor to an assembly facility where the optical fiber will be automatically integrated into an optical assembly. In addition, the spool serves to maintain and align the fiber during testing operations at which time light is propagated through the fibers, without manual manipulation.

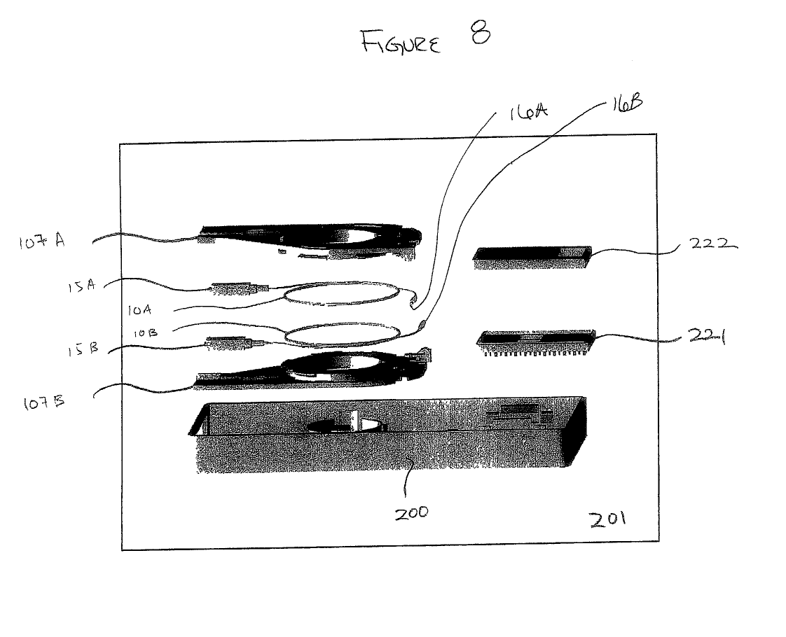

A multiple-spool assembly, such as that shown in FIG. 7, or a single spool assembly, such as those shown in FIGS. 1-6, can be inserted into a cassette, as described more fully with reference to FIGS. 8-10, 14B, 14A and 15. As shown in FIG. 8 illustrating cassette assembly (201), a cassette (200) is designed to capture and retain an electronic module (221) and, in the illustrated embodiment, two spools (107A & 107B). The cassette (200) facilitates assembly and transportation of optical assemblies (comprising, in this illustration, two optical fibers (10A & 10B) and an electronic module (221)). Thus, the cassette assembly (201) performs double duty as a fixture for retaining the electronic module (221), bonding fiber ends (16A and 16B) to electronic module (221), and presenting the fiber connectors (15A & 15B) for connection to a light source/sensor, as well as a protective device for shipment of finished assemblies.

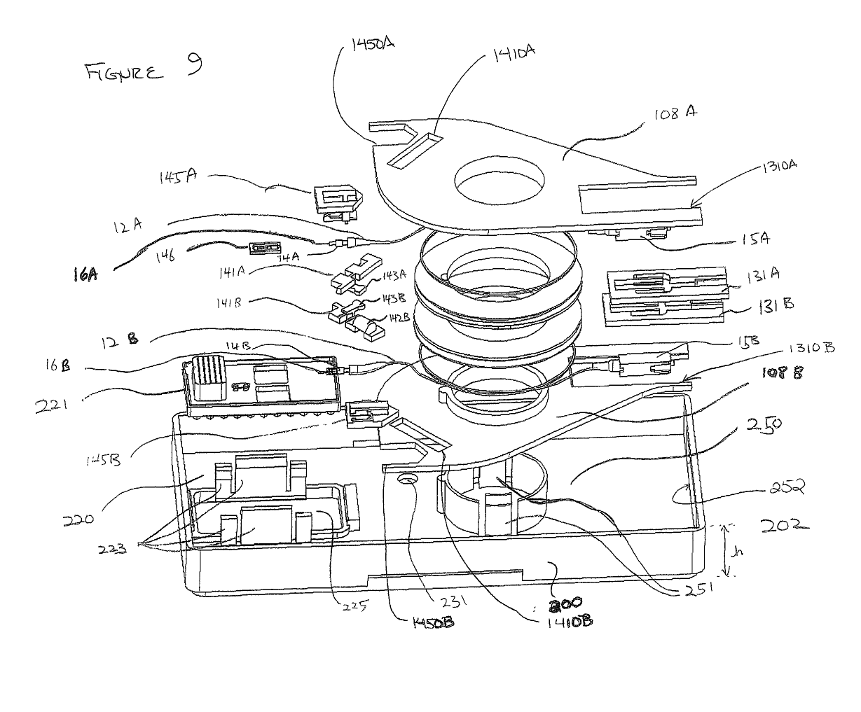

With reference to FIG. 9, illustrating an exploded view of a cassette assembly (202), cassette (200) comprises a spool receiving area (250) for receiving one or more spools (108A & 108B). The spools (108A & 108B) may be retained securely in the spool receiving area (250) by spool latches (251). The fiber connector (15B) may be inserted into the connector clip (131B) and the fiber end (16B) of the assembly end (12B) may be inserted into the fiber end latch (141B). The connector clip (131B) and the fiber end latch (141B) may be inserted in the spool (108B) at connector clip insert (1310B) and fiber end latch insert (1410B), respectively. Furthermore, the optical bench adapter (145B) may be inserted in the spool (108B) at optical bench adapter insert (1450B). Similarly, fiber connector (15A) may be inserted into the connector clip (131 A) and the fiber end (16A) of the assembly end (12A) may be inserted into the fiber end latch (141A). The connector clip (131A) and the fiber end latch (141A) may be inserted in the spool (108A) at connector clip insert (1310A) and fiber end latch insert (1410A), respectively. The optical bench adapter (145A) may be inserted in the spool (108A) at optical bench adapter insert (1450A). Typically, optical bench (146) is obtained from a storage device by automatic assembly equipment and placed into a fixture. Assembly end (12A) is taken from fiber end latch (141A) by the assembly equipment, aligned to the fixtured optical bench (146), and epoxied. The completed assembly comprising the optical bench (146) and the fiber is then placed into the optical bench adapter (145A). In alternate embodiments, however, the optical bench (146) remains in the cassette (200) while being epoxied to the assembly end (12A).

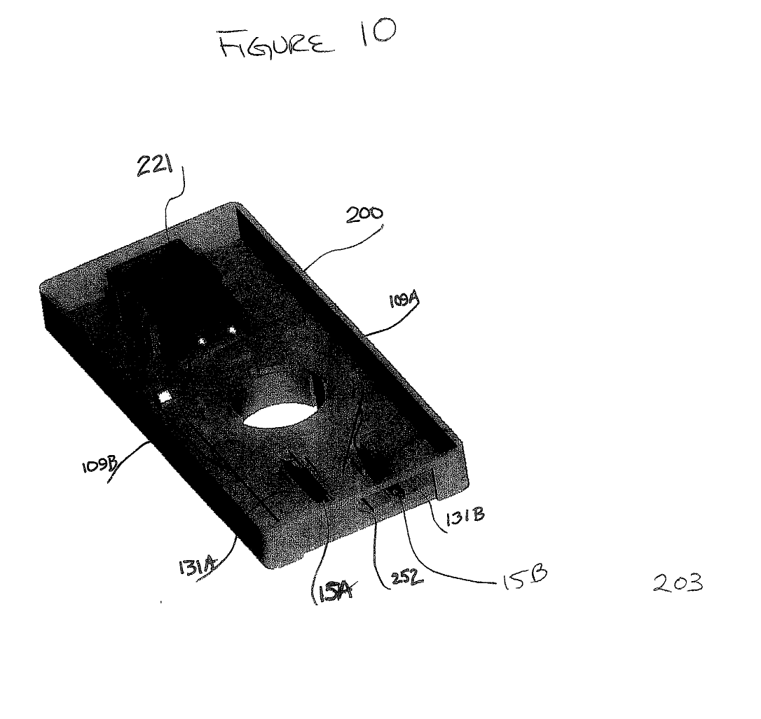

As shown further in FIG. 9, the height (designated by “h”) of the cassette (200) may be designed to accommodate any given number of spools (in this embodiment, two spools (108A & 108B)) consistent with the number of optical fibers desired in the cassette assembly (202). The spool assembly hole (252) (also shown in FIG. 10) provides access to fiber connectors (15A & 15B) by automatic assembly equipment, if required. With further reference to FIG. 9, the cassette (200) further comprises an electronic module receiving area (220) for receiving an electronic module (221). The electronic module (221) is retained securely by module latches (223). The design of module latches (223) may be variable depending on the physical design of electronic module (221). The module assembly hole (225) located in the electronic module receiving area (220) provides access to the electronic module (221) by assembly equipment. The positioning of the electronic module (221) in electronic module receiving area (220) facilitates automatic connection of the fiber ends (16A & 16B) of the optical fibers (10A & 10B), respectively, to the electronic module (221). Once the spools (108A & 108B) and the electronic module (221) are properly loaded in the cassette (200), the cassette assembly (202) can be used to ship the electro-optical device and/or for further processing of optical assemblies.

FIG. 10 shows a two-spool assembly that has been inserted into a cassette and has had the ends of its optical fibers secured to an electronic module, as described with reference to FIG. 9.

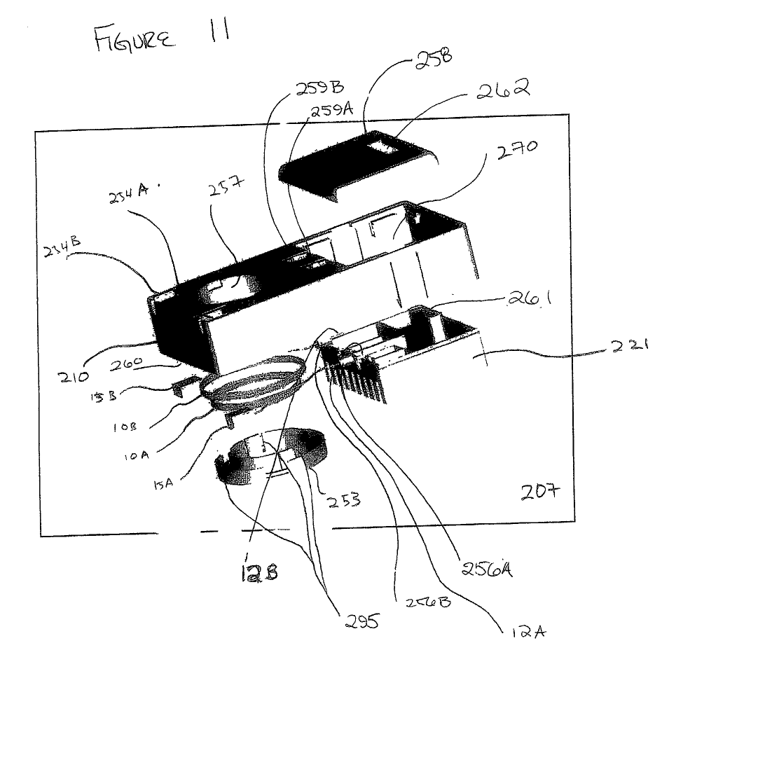

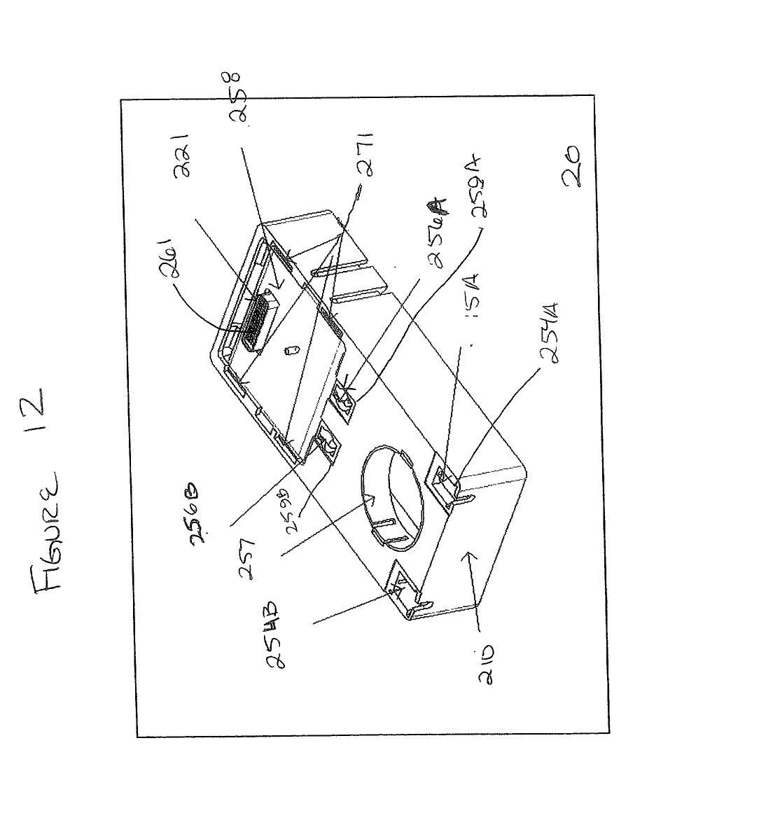

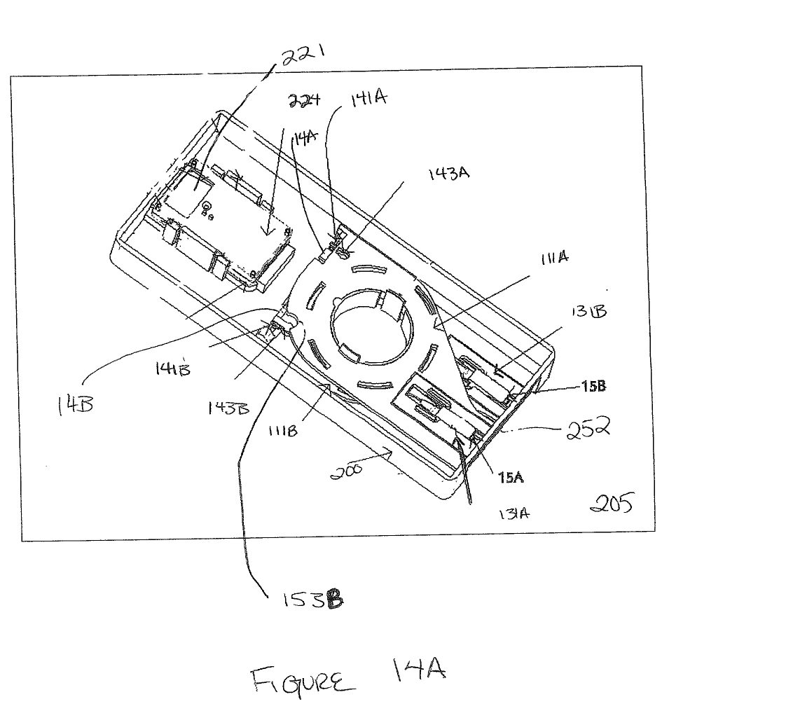

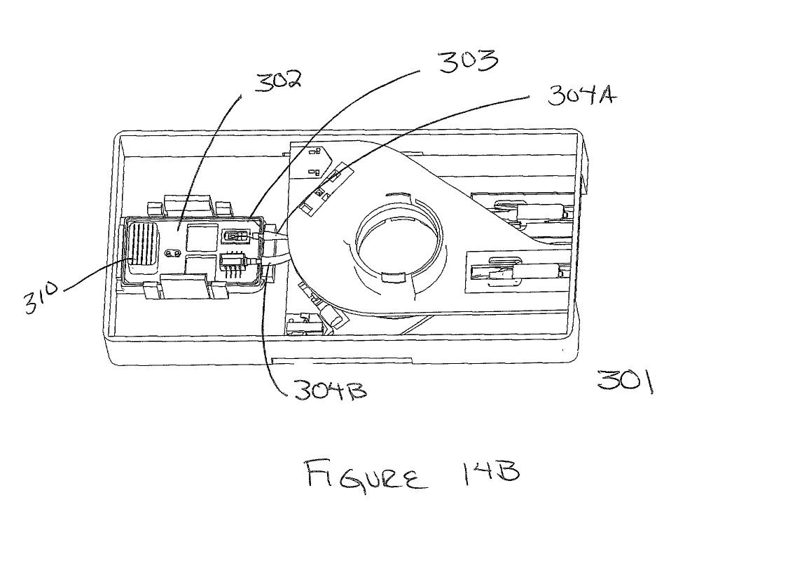

In another preferred embodiment of the present invention, as shown in FIGS. 11, 12, and 13, a cassette (210) receives the lengths of optical fiber (10A & 10B) directly, without use of the separate spool(s) described herein. In the cassette assembly (207) of FIG. 14, the cassette (210) and spool drum (257) are a single, integral unit. The cassette (210) comprises an electronic module receiving area (270) for receiving an electronic module (221). The electronic module (221) may be inserted in the electronic module receiving area (270) and retained by electronic module latches (271), shown in FIG. 12. With reference to FIG. 11, the cassette (210) also comprises a fiber receiving area (260) on the underside of cassette (210), that receives the lengths of optical fiber (10A & 10B).

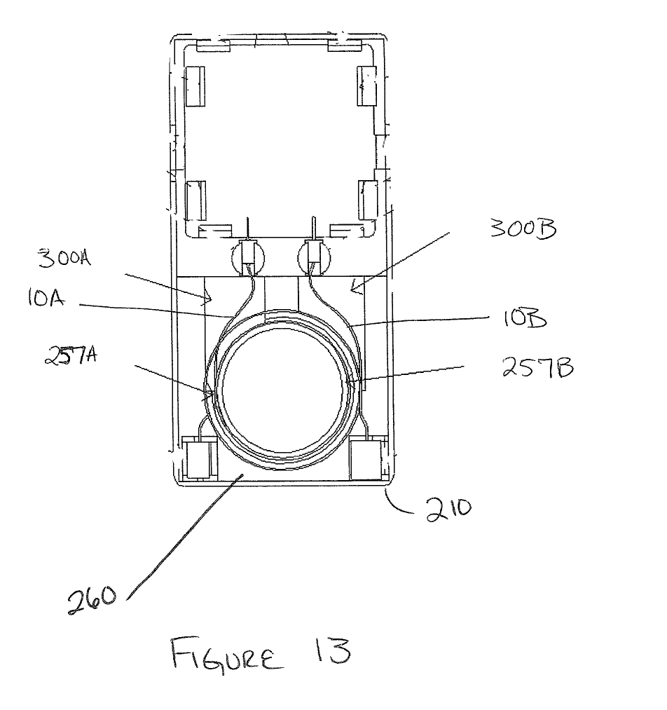

Spool drum (257) includes one or more stepped concentric rings around which individual fibers may be wound. As shown in FIG. 13, which shows the underside of cassette (210) spool drum (257) includes two stepped rings (257A & 257B) for receiving optical fibers (10A & 10B). Molded cuts in the rings allow the fibers from inner rings to pass to the exterior of the largest ring. Molded depressions in the floor of the cassette (210) allow the fibers from the inner ring (257A) to pass under fibers wound the larger diameter ring (257B). To ensure that the optical fibers (10A & 10B) do not commingle and/or entangle, a retainer (253) is snapped onto cassette (210) over spool drum (257). Retainer (235) includes cutouts (295) to preclude crimping of the optical fibers as they cross over fibers wound on larger rings. To eliminate stress on the fiber that may occur during manipulation during assembly, the cassette (210) includes draw areas (300A & 300B), which allow for some excess fiber to be loosely held between fiber end latches (256A & 256B) and fiber holder (260).

As shown in FIGS. 11 and 12, the fiber connectors (15A & 15B), into which one end of each length of optical fiber (10A & 10B) has been inserted, may be inserted into connector channels (254A & 254B), respectively. The assembly ends (12A & 12B) may be inserted into fiber end latches (256A & 256B) and inserted into fiber end latch receiving areas (259A & 259B). An electronic module cap (258) may be coupled to the cassette (210) such that it covers all or part of electronic module (221). The electronic module cap (258) may include a hole (262) to allow for protrusion of power connector (261) of electronic module (221). This design facilitates connection of the electronic module (221) to a power supply.

As shown in FIG. 12, the placement of the connector channels (254A & 254B) facilitates automatic connection of the fiber connectors (15A & 15B) to assembly equipment, if required. Further, the placement of the electronic module (221) in relative location to fiber end latch receiving areas (259A & 259B), into which fiber end latches (256A & 256B) have been inserted, facilitates automatic connection of the assembly ends (12A & 12B) to the electronic module (221).

Thus, the system shown in FIGS. 11, 12 and 13 facilitates shipment of fibers to a manufacturing area, retaining an electronic module while presenting the fibers for assembly, and protecting the finished assemblies during storage and shipment.

The specific preferred embodiments described herein, and all of those embodiments that fall within the scope of the present invention, may be used to facilitate automatic assembly of optical devices. In particular, an optical fiber may be captured on a spool of the present invention, as described with reference to FIGS. 1-7, by automatic assembly equipment. Then, an electronic module and a desired number of spools may be loaded into a cassette by automatic assembly equipment. For example, with reference to FIG. 14A, an electronic module (221), covered by electronic module cover (224), and two spools (111A & 111B) have been loaded into cassette (200) to form the cassette assembly (205). The assembly equipment may, if required, automatically connect to the connectors (15A & 15B) retained in the connector clips (131A & 131B) through the spool assembly hole (252) (also shown in FIG. 10) in the cassette (200). Alternatively, connectors (15A & 15B) are precisely positioned in cassette (200) such that connection to a light source/sensor can be made without use of assembly equipment.

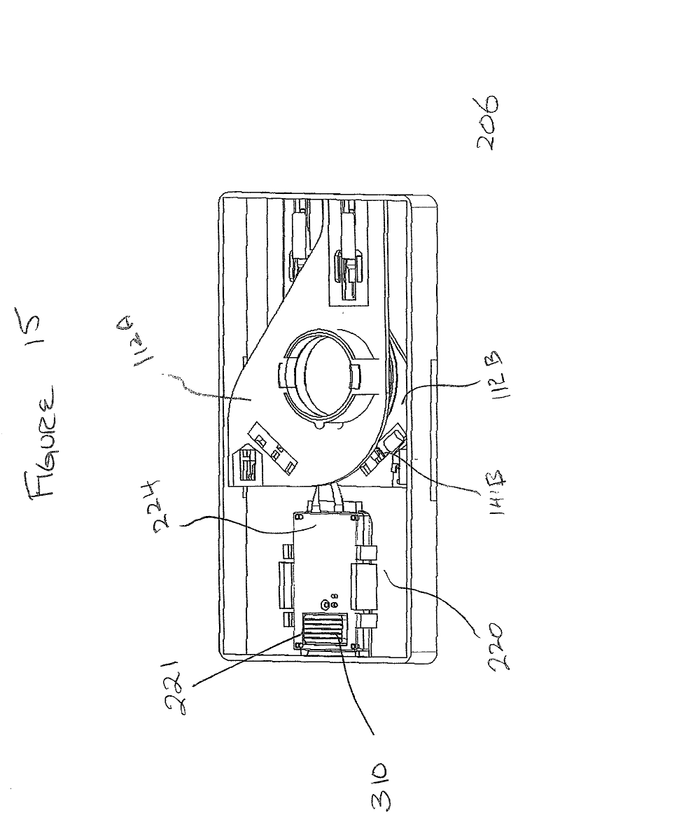

As further shown in FIG. 14A, the placement of the electronic module (221) and the spools (111A & 111B) in cassette (200) allows automatic assembly equipment to grip the optical fibers (hidden here), by releasing ferrules (14A & 14B) from the fiber end latches (141A & 141B) (as shown in FIG. 9) by having the automatic assembly equipment exert pressure on their respective tabs (143A & 143B), and to position the fiber ends (16A & 16B) (as shown in FIG. 8) towards the electronic module (221) for assembly. The tab (143A) of the spool (111A) can be accessed through the tab access hole (231) in the underside of the cassette (200), as shown in FIG. 9. The tab (143B) of spool (111B) can be accessed through a tab access notch (153B) of spool (111A), as shown in FIG. 14A. An alternative embodiment of a cassette assembly (206), as shown in FIG. 15, allows direct access to the fiber end latch (141B) of the spool (112B), thereby eliminating any need for a tab access notch. FIG. 14B shows cassette assembly (301) and includes electronic module (302) without a cover. Thus, bonding area (303) of electronic module (302) is open and allows for an assembly machine to grip the ferrules (304A & 304B) upon their release, move them to the bonding area (303), and bond the fiber ends (not shown) to the electronic module (302). Thus, both FIGS. 14B and 15 show embodiments in which fiber ends have been bonded to electronic module (221). In alternative embodiments, the electronic module (221) is held in a fixture, outside the cassette, during the bonding process and placed back into cassette by automatic assembly equipment upon completion.

As shown in FIG. 15, the design of the electronic module receiving area (220) allows further processing as desired while securely retaining both the electronic module (221) and the spools (112A & 112B). The design also allows access to the internals of the electronic module (221) either from above or from beneath the electronic module (221), through the module assembly hole (225), shown in FIG. 9. In some embodiments, an electronic module cover (224), as shown in FIG. 15, is used to cover electronic module (221). As also shown in FIG. 15, a power source can be connected to electronic module (221) by automatic assembly equipment via power connector (310). While these assembly steps are described above as being performed automatically by assembly equipment, one or more of these steps may be performed manually.

A cassette assembly of the present invention can be used in further handling and processing of the optical fibers and the electronic module without need for any additional packaging or carriers. Furthermore, the cassette assembly may serve as a shipping container. The cassette assembly may be inserted into packaging material or wrapped in shrink material for transporting to the end user who may, in order to use the fibers and electronic module in an optical assembly, remove the electronic module (221) from the cassette (200), remove the spools (109A & 109B), unclip the fiber connectors (15A & 15B) and remove the optical fibers from the spools (109A & 109B) as shown, for example, in FIG. 10.

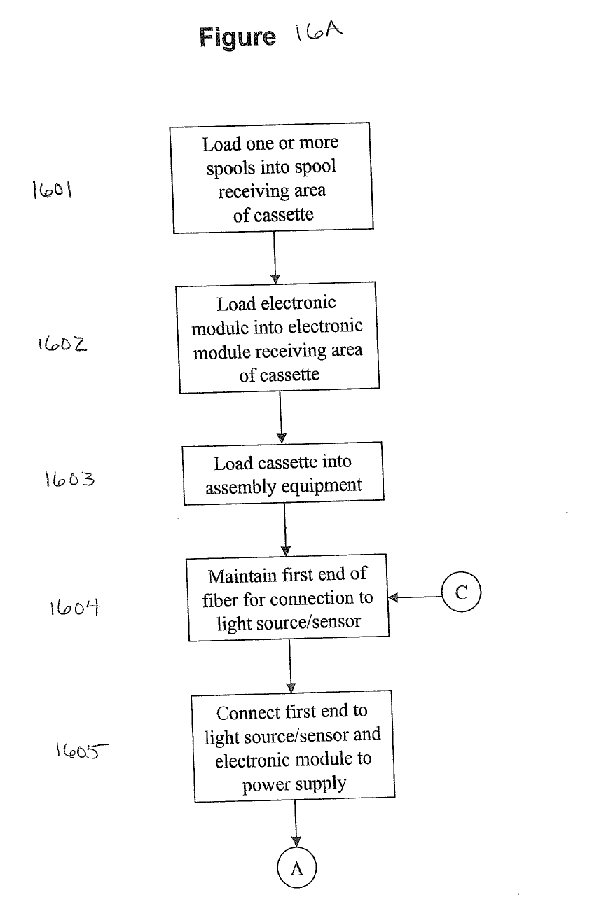

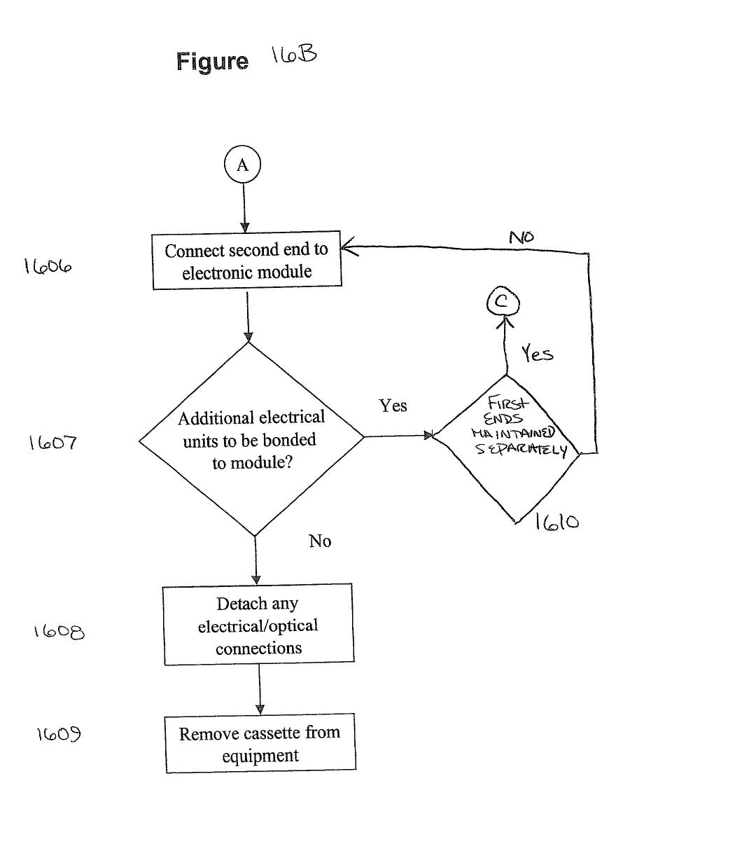

Methods for carrying out the objects of the present invention are described with reference to FIGS. 16A, 16B, 17A, 17B, 17C and 18. With reference to FIGS. 16A and 16B, a preferred embodiment of a method for automatically assembling an electro-optical device is illustrated. The electro-optical device includes a cassette, one or more spools, and an electronic module. In step 1601, one or more spools are loaded into a spool receiving area of the cassette. The spools each capture a length of optical fiber, which includes a first end and a second end. In step 1602, the electronic module is loaded into an electronic module receiving area of the cassette. In step 1603, the cassette is loaded into assembly equipment. In step 1604, the first end of the fiber is maintained for connection to a light source/sensor, with or without use of automatic assembly equipment. In step 1605, the first end of the fiber is connected to a light source/sensor and the electronic module is connected to a power supply, if required. In step 1606, the second end of the fiber is connected to the electronic module by automatic assembly equipment. In some embodiments, this step is performed while the electronic module is not retained in the cassette (i.e., either before it is loaded into the cassette or it is removed from the cassette for the connection procedure). In the preferred embodiment, connecting the second end of the fiber to the electronic module is accomplished by, first, bonding the second end of the fiber to an electronic unit (using a very accurate and precise connection) and, then, bonding the electronic unit to the electronic module. In alternate embodiments, the electronic unit is bonded to the electronic module and, then, the second end of the fiber is bonded to the electronic unit. In step 1607, it is determined whether the assembly includes additional fibers/electronic units to be bonded to the electronic module. If so, it is determined in step 1610 whether the fist ends are maintained separately. If so, the process repeats from step 1604 and, if not, the process repeats from step 1606. If it is determined that the assembly does not include additional fibers/electronic units to be bonded to the electronic module, in step 1608, any electronic and optical connections are detached and, in step 1609, the cassette is removed from the assembly equipment.

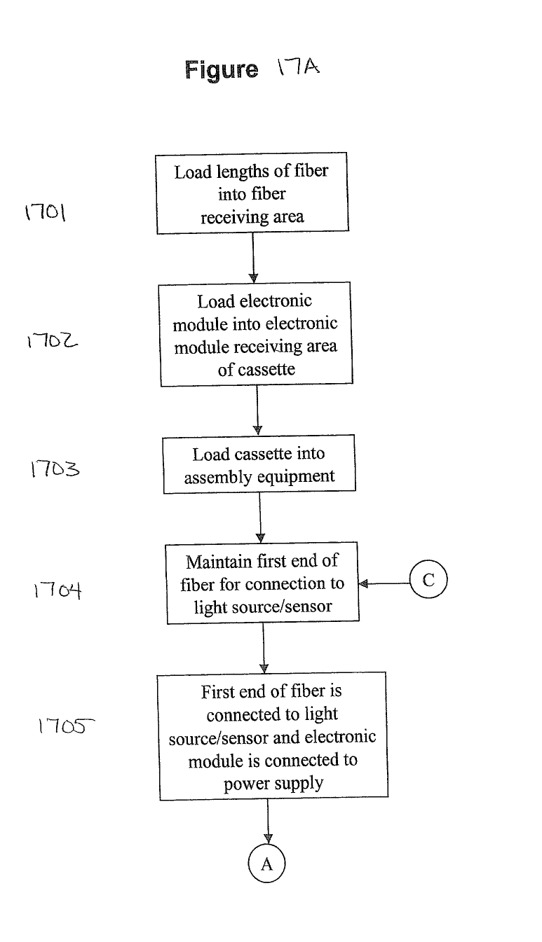

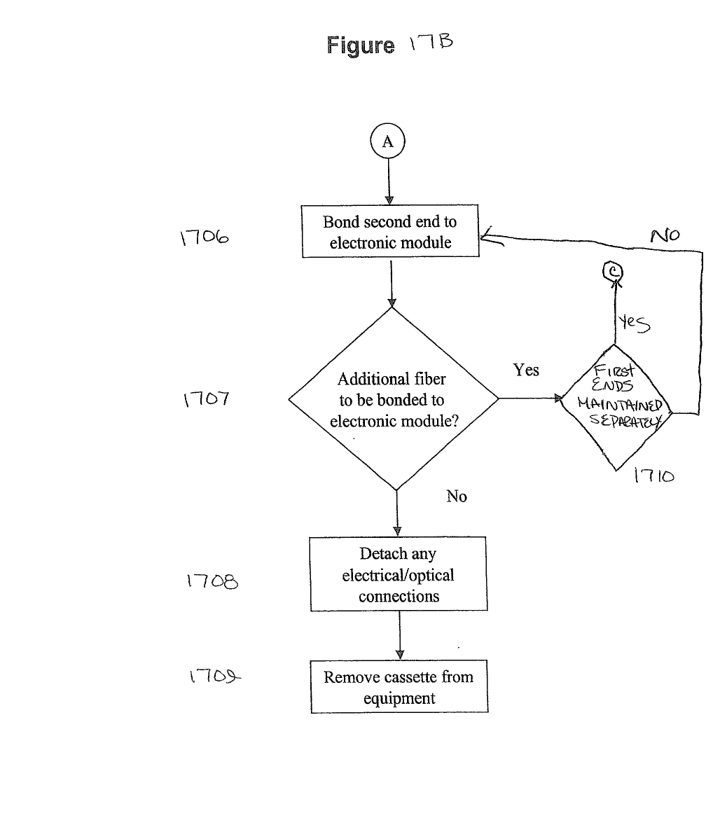

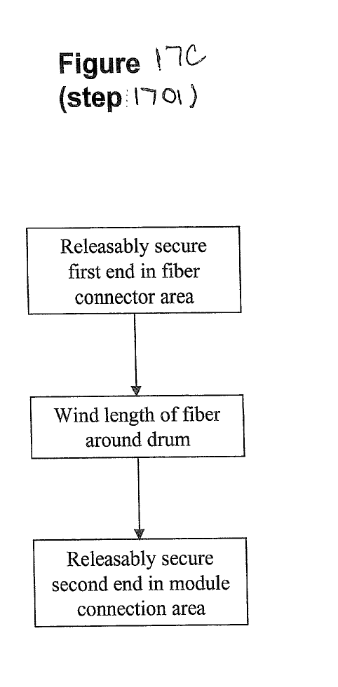

With reference to FIG. 17A, a preferred embodiment of a method for automatically assembling an electro-optical device is illustrated. The electro-optical device includes a cassette, one or more lengths of optical fiber, and an electronic module. In step 1701, the lengths of optical fiber (each including a first end and a second end) are loaded into an optical fiber receiving area of the cassette and a cover is placed over the area to retain the fiber. In step 1702, an electronic module is loaded into an electronic module receiving area of the cassette. In step 1703, the cassette is loaded into assembly equipment. In step 1704, the first end of the fiber is maintained for connection to a light source/sensor, with or without use of automatic assembly equipment. In step 1705, the first end of the fiber is connected to a light source/sensor and the electronic module is connected to a power supply, if required. In step 1706, the second end is picked up by assembly equipment and bonded to the electronic module. In one embodiment the second end is positioned in the electronic module on the electronic unit and bonded to the electronic unit installed in the electronic module receiving area of the cassette. In step 1707, it is determined whether the assembly includes additional fiber ends to be bonded to the electronic module. If so, it is determined in step 1710 whether the first ends are maintained separately. If so, the process repeats from step 1704 or, if not, the process repeats from step 1706. If it is determined that the assembly does not include additional fiber ends to be bonded to the electronic module, in step 1708, any electronic and optical connections are detached and, in step 1709, the cassette is removed from the equipment.

In certain embodiments, the cassette further includes a drum, a fiber connector area and a module connection area. In this embodiment, step 1701 includes, as shown in FIG. 17C, releasably securing the first end in the fiber connector area in step 1710; winding the length of optical fiber around the drum in step 1720; and releasably securing the second end in the module connection area in step 1730. In other embodiments, the lengths of optical fiber are pre-loaded into the optical fiber receiving area of said cassette and step 1701 is not necessary.

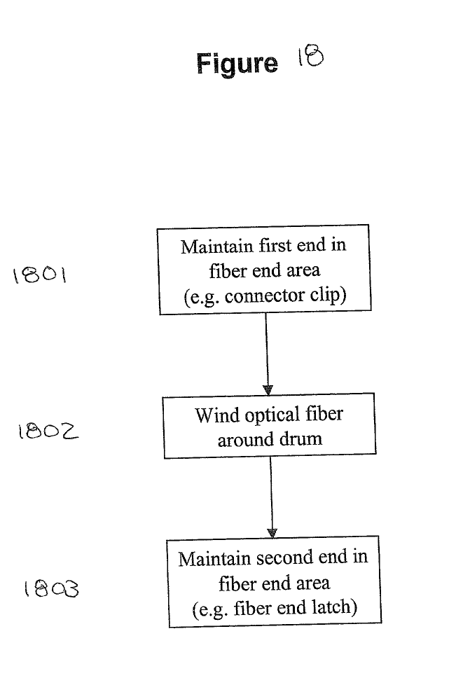

With reference to FIG. 18, a method for automatically assembling a spool that transports of a length of optical fiber (including a first end and a second end) is shown. The spool includes a drum and a spool base, which may be separate pieces or comprise a single unit. The spool base includes at least two fiber end areas. In some embodiments, one fiber end area is a fiber connector area (which includes a connector clip) and a second fiber end area is a module connection area (which includes a fiber end latch). In step 1801 of the method, the first end of the fiber is maintained in one fiber end area (for example, is inserted into the connector clip). In step 1802, the length of optical fiber is wound around the drum by automatic assembly equipment. In step 1803, the second end is maintained in a second fiber end area (for example, is inserted into the fiber end latch).

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method for automatically assembling an electro-optical device, wherein said electro-optical device comprises a cassette, one or more spools, and an electronic module, said method comprising the steps of:
(A) loading said one or more spools into a spool receiving area of said cassette, wherein said spools each capture a length of optical fiber, and wherein said length of optical fiber comprises a first end and a second end;
(B) loading said electronic module into an electronic module receiving area of said cassette;
(C) maintaining said first end for connection to a light source or a light sensor; and
(D) maintaining said second end for connection to said electronic module.

2. A method for automatically assembling an electro-optical device, wherein said electro-optical device comprises a cassette, one or more lengths of optical fiber, and an electronic module, said method comprising the steps of:
(A) loading said one or more lengths of optical fiber in an optical fiber receiving area of said cassette, wherein said one or more lengths of optical fiber each comprise a first end and a second end;
(B) loading said electronic module into an electronic module receiving area of said cassette;
(C) maintaining said first end for connection to a light source or a light sensor; and
(D) maintaining said second end for connection to said electronic module.

3. The method of claim 2, wherein said cassette further comprises a drum, a fiber connector area and a module connection area, and wherein step (A) comprises the steps of:
(E) releasably securing said first end in said fiber connector area;
(F) winding said length of optical fiber around said drum; and
(G) releasably securing said second end in said module connection area.

4. The method of claim 1 or 2, wherein step (D) further comprises bonding said second end to said electronic module.

5. The method of claim 1 or 2, wherein step (D) further comprises welding said second end to said electronic module.

6. The method of claim 1 or 2 further comprising the step of:
(E) powering said electronic module.

7. A method for automatically assembling an electro-optical device, wherein said electro-optical device comprises an electronic module, a cassette, and one or more lengths of optical fiber each comprising a first end and a second end, wherein said lengths of optical fiber have been loaded into an optical fiber receiving area of said cassette, said method comprising the steps of:
(A) loading said electronic module into an electronic module receiving area of said cassette;
(B) maintaining said first end for connection to a light source or a light sensor; and
(C) maintaining said second end for connection to said electronic module.

8. The method of claim 7, wherein step (C) comprises bonding said second end to said electronic module.

9. The method of claim 7, wherein step (C) comprises welding said second end to said electronic module.

10. The method of claim 7 further comprising the step of:
(D) powering said electronic module.
